(19) United States
(12) Patent Application Publication
(10) Pub. No.: US 2006/0038321 A1
(43) Pub. Date: Feb. 23, 2006

(54) METHOD AND APPARATUS FOR FORMING DEEP APERTURES IN A GOLF BALL, AND GOLF BALL

(75) Inventors: Michael J. Tzivanis, Chicopee, MA (US); Vincent J. Simonds, Brimfield, MA (US); Thomas F. Bergin, Holyoke, MA (US); Thomas A. Veilleux, Charlton, MA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, Carlsbad, CA (US)

(21) Appl. No.: 11/164,041

(22) Filed: Nov. 8, 2005

Related U.S. Application Data
(63) Continuation-in-part of application No. 10/305,531, filed on Nov. 27, 2002.
(60) Provisional application No. 60/337,123, filed on Dec. 4, 2001.
(60) Provisional application No. 60/356,400, filed on Feb. 11, 2002.
(60) Provisional application No. 60/422,247, filed on Oct. 30, 2002.

(51) Int. Cl. B29B 13/00

(52) U.S. Cl. 264/271.1; 264/328.12; 264/275

(57) ABSTRACT

A method and apparatus for forming a golf ball are disclosed herein. The method and apparatus involve biasing a golf ball precursor product toward a first side of a mold cavity in anticipation of movement of the golf ball precursor product toward a second side of the mold cavity during the formation of a cover for the golf ball. In order to bias the golf ball precursor product, at least one of a second plurality of protrusions that extend inward from a second side of an interior surface wall has a length that is greater than each of a first plurality of protrusions that extend inward from a first side of the interior surface wall. A golf ball having greater cover concentricity is also disclosed herein.

### CROSS REFERENCES TO RELATED APPLICATIONS

The present application is a continuation-in-part application of U.S. patent application Ser. No. 10/305,531, filed on Nov. 27, 2002, which claims priority to U.S. Provisional Patent Application No. 60/337,123, filed Dec. 4, 2001; U.S. Provisional Patent Application No. 60/356,400, filed Feb. 11, 2002; and U.S. Provisional Patent Application No. 60/422,247, filed Oct. 30, 2002.

### BACKGROUND OF THE INVENTION

1. Field of the Invention

The present invention relates to a method and apparatus for forming a golf ball, and a golf ball formed from the method.

2. Description of the Related Art

Golf balls are typically made by molding a core of elastomeric or polymeric material into a spheroid shape. A cover is then molded around the core. Sometimes, before the cover is molded about the core, an intermediate layer is molded about the core and the cover is then molded around the intermediate layer. The molding processes used for the cover and the intermediate layer are similar and usually involve either compression molding or injection molding.

In compression molding, the golf ball core is inserted into a central area of a two piece die and pre-sized sections of cover material are placed in each half of the die, which then clamps shut. The application of heat and pressure molds the cover material about the core.

Blends of polymeric materials have been used for modern golf ball covers because certain grades and combinations have offered certain levels of hardness to resist damage when the ball is hit with a club and elasticity to allow responsiveness to the hit. Some of these materials facilitate processing by compression molding, yet disadvantages have arisen. These disadvantages include the presence of seams in the cover, which occur where the pre-sized sections of cover material were joined, and long process cycle times which are required to heat the cover material and complete the molding process.

Injection molding of golf ball covers arose as a processing technique to overcome some of the disadvantages of compression molding. The process involves inserting a golf ball core into a die, closing the die and forcing a heated, viscous polymeric material into the die. The material is then cooled and the golf ball is removed from the die. Injection molding is well-suited for thermoplastic materials, but has limited application to some thermosetting polymers. However, certain types of these thermosetting polymers often exhibit the hardness and elasticity desired for a golf ball cover. Some of the most promising thermosetting materials are reactive, requiring two or more components to be mixed and rapidly transferred into a die before a polymerization reaction is complete. As a result, traditional injection molding techniques do not provide proper processing when applied to these materials.

Reaction injection molding is a processing technique used specifically for certain reactive thermosetting plastics. As mentioned above, by “reactive” it is meant that the polymer is formed from two or more components which react. Generally, the components, prior to reacting, exhibit relatively low viscosities. The low viscosities of the components allow the use of lower temperatures and pressures than those utilized in traditional injection molding. In reaction injection molding, the two or more components are combined and reacted to produce the final polymerized material. Mixing of these separate components is critical, a distinct difference from traditional injection molding.

The process of reaction injection molding a golf ball cover involves placing a golf ball core into a die, closing the die, injecting the reactive components into a mixing chamber where they combine, and transferring the combined material into the die. The mixing begins the polymerization reaction which is typically completed upon cooling of the cover material.

For certain applications it is desirable to produce a golf ball having a very thin cover layer. However, due to equipment limitations, it is often very difficult to mold a thin cover. Accordingly, it would be beneficial to provide an apparatus and technique for producing a relatively thin cover layer.

Moreover, retractable pins have been utilized to hold, or center, the core or core and mantle and/or cover layer(s) in place within an injection mold while molding an outer cover layer thereon. In such processes, the core or mantled ball is supported in the mold using retractable pins extending from the inner surface of the mold to the outer surface of the core or mantled ball. The pins in essence support the core or mantled ball while the cover layer is injected into the mold. Subsequently, the pins are retracted as the cover material fills the void between the core or mantle and the inner surface of the mold.

However, notwithstanding, the benefits produced through the use of the retractable pins, the pins sometimes produce centering difficulties and cosmetic problems (i.e. pin flash, pin marks, etc.) during retraction, which in turn require additional handling to produce a golf ball suitable for use and sale. Additionally, the lower the viscosity of the mantle and/or cover materials, the greater the tendency for the retractable pins to stick due to material accumulation, making it necessary to shut down and clean the molds routinely.

Further, a core or a core with a mantle layer may shift within a mold cavity due to the injection force of the cover material, resulting in a cover with thickness variance from one side to the other. The core or core with a mantle layer may also shift within a mold due to the force of gravity and material composition. For example, if a mold is heated and the mantle layer or core is softened by the heating, the core or core with mantle layer may shift within the mold cavity.

Thus, it would be beneficial to provide a means for maintaining the concentricity of the cover during the cover formation process, especially for a cover formed by reaction injection molding.

### BRIEF SUMMARY OF THE INVENTION

The present invention provides a method and apparatus for biasing a golf ball precursor product to maintain the concentricity of the cover. To accomplish this, one side of an interior surface wall of a mold cavity has at least one of a plurality of protrusions that is greater in length than a plurality of protrusions extending from a second side of the interior surface wall of the mold cavity.

One aspect of the present invention is a method for forming a golf ball. The method begins with placing a golf ball precursor product within a cavity of a mold. An interior surface wall of the mold defines the cavity. The interior surface wall of the mold has a first side and a second side. The golf ball precursor product is positioned on a first plurality of protrusions extending from the first side and a second plurality of protrusions extending from the second side. At least one protrusion of the second plurality of protrusions has a length as measured from the interior surface wall inward toward the cavity that is greater than the length of each of the first plurality of protrusions. Further, a flowable material is introduced into the cavity. Further, the golf ball precursor product is moved toward the second side of the interior surface of the mold from a force. Then, a cover is formed from the flowable material over the golf ball precursor product. The cover has a plurality of deep apertures formed by each of the first plurality of protrusions and the second plurality of protrusions.

Another aspect of the present invention is a method for forming a golf ball which begins with
biasing a golf ball precursor product toward a first side of an interior surface wall which defines a cavity of a reaction injection mold. Next, a flowable material is introduced into the cavity, with the flowable material consisting of a reacting mixture of an isocyanate component and a polyol component. The flowable material is introduced into the cavity at a force ranging from 50 psi to 1000 psi. Next, the golf ball precursor product is forced toward a second side of the interior surface wall. Next, a reaction injection molded polyurethane cover is formed over the golf ball precursor product. The reaction injection molded polyurethane cover has a thickness ranging from 0.010 inch to 0.050 inch and a concentricity within 0.003 inch.

Yet another aspect of the present invention is an apparatus for forming a golf ball. The apparatus includes an interior surface wall defining a cavity, a first plurality of protrusions, a second plurality of protrusions, a flow channel and an exit channel. The interior surface wall has a first side, a second side and an inverse aerodynamic pattern surface. The first plurality of protrusions extend from the first side of the interior surface wall, with each of the first plurality of protrusions having a first length. The second plurality of protrusions extend from the second side of the interior surface wall, with at least one protrusion of the second plurality of protrusions having a second length which is greater than the first length. The flow channel introduces a flowable material into the cavity through a gate in the interior surface wall. The exit channel receives excess flowable material from the cavity through a vent located in the interior surface wall.

Yet another aspect of the present invention is a golf ball including a golf ball precursor product and a cover. The golf ball precursor product has a diameter ranging from 1.54 inches to 1.70 inches. The cover is disposed over the golf ball precursor product. The cover is formed from a reaction injection molded polyurethane. The cover has a thickness ranging from 0.010 inch to 0.050 inch. A surface of the cover has an aerodynamic pattern. The cover has a first plurality of deep apertures on a first hemisphere of the golf ball and a second plurality of deep apertures on a second hemisphere of the golf ball. Each of the first plurality of deep apertures has a first depth and each of the second plurality of deep apertures has a second depth. The second depth is greater than the first depth. Each of the first plurality of deep apertures and the second plurality of deep apertures extends through the cover.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a perspective view revealing the components of a golf ball.

FIG. 2 is a perspective view of a preferred embodiment molding assembly.

FIG. 2A is a cross-sectional view of a mold.

FIG. 2B is a cross-sectional view of a mold.

FIG. 3 is a planar view of a portion of the preferred embodiment molding assembly taken in the direction of line 3-3 in FIG. 2.

FIG. 4 is a planar view of a portion of the preferred embodiment molding assembly taken in the direction of line 4-4 in FIG. 2.

FIG. 5 is a detailed perspective view of a portion of the preferred embodiment molding assembly taken in the direction of line 5-5 in FIG. 2.

FIG. 6 is a detailed view of the peanut after-mixer of the preferred embodiment molding assembly.

FIG. 7 is a planar view of a portion of an alternative embodiment of the molding assembly.

FIG. 8 is a planar view of a portion of an alternative embodiment of the molding assembly.

FIG. 9 is a planar view of a portion of an alternative embodiment of the molding assembly.

FIG. 10 is a flow chart illustrating a method of the present invention.

FIG. 10A is a flow chart illustrating a method of the present invention.

FIG. 10B is a flow chart illustrating a method of the present invention.

FIG. 11 is a cross-sectional view of another preferred embodiment golf ball according to the present invention having a core and a single cover layer having apertures, wherein one or more of the apertures extends through the cover to and/or into the underlying core.

FIG. 12 is a diametrical cross-sectional view of the preferred embodiment golf ball illustrated in FIG. 11.

FIG. 13 is a cross-sectional view of another preferred embodiment golf ball having a core component and a cover component, wherein the cover component includes an inner cover layer and an outer cover layer having apertures formed therein, and wherein one or more of the apertures of the outer cover layer extends to and/or into the underlying inner cover layer.

FIG. 14 is a diametrical cross-sectional view of the preferred embodiment golf ball illustrated in FIG. 13.

### DETAILED DESCRIPTION OF THE INVENTION

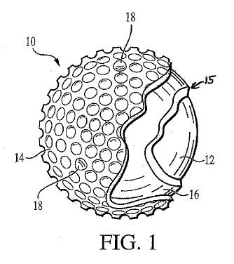

As shown in FIG. 1, a preferred embodiment of a golf ball 10 generally includes a central core 12 which may be solid or liquid as known in the art. A cover 14 is disposed about the central core 12. In the embodiment of FIG. 1, a mantle or intermediate layer 16 is present between the central core 12 and the cover 14. However, those skilled in the pertinent art will recognize that two-piece and multiple-layer golf balls with four or more layers are within the scope of the present invention. The preferred embodiment golf ball 10 includes one or more deep apertures 18 that extend through at least the cover layer 14. The deep apertures 18 extend to, or through, the mantle layer 16. In alternative embodiments, the deep apertures may further extend through the mantle layer 16 and into the core 12. It will be appreciated that in the event the core is liquid, the deep apertures will not extend to the core.

The deep apertures extend through the outermost cover layer of the ball, to or into or through one or more components underneath the outermost cover layer. As explained herein, the deep apertures result from one or more outwardly extending projections or protrusions that are provided in a molding chamber used for molding the final ball. The protrusions generally have a height greater than other raised regions along the molding surface that form an aerodynamic pattern on an exterior surface of the golf ball 10. Such aerodynamic patterns include a tubular lattice network such as disclosed in U.S. Pat. No. 6,290,615 for a Golf Ball Having A Tubular Lattice Pattern, which is hereby incorporated by reference in its entirety, and U.S. Pat. No. 6,331,150 for Golf Ball Dimples With Curvature Continuity which is hereby incorporated by reference in its entirety. Those skilled in the pertinent art will recognize that many other aerodynamic patterns may be used in practicing the present invention.

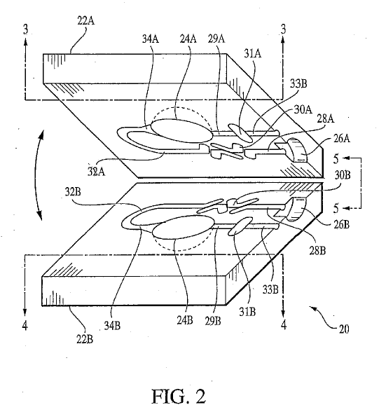

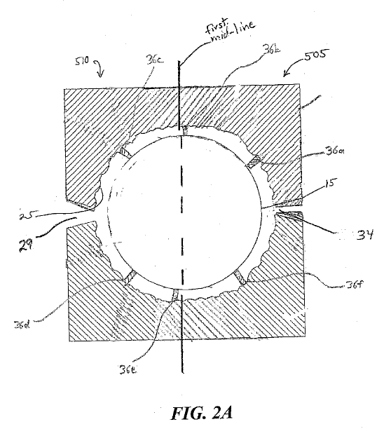

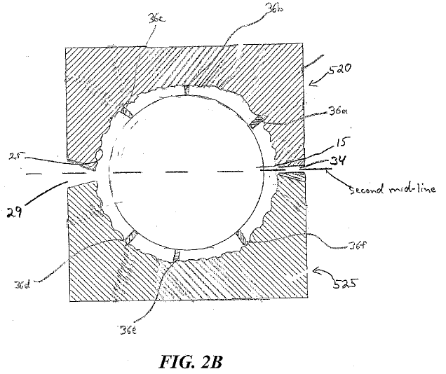

As shown in FIG. 2, a perspective view of a preferred embodiment of the molding assembly is generally designated 20. The molding assembly 20 preferably comprises an upper half 22A and a lower half 22B. As will be appreciated, the upper and lower halves 22A and 22B are preferably formed from a metal or suitable material. A mixing chamber may, as known in the art, precede the molding assembly 20.

As shown in FIGS. 2A and 2B, a golf ball precursor product 15 is positioned within a cavity 24 which is formed from the two hemispherical depressions 24A and 24B defined in an interior surface wall 25 of the upper half 22A and lower half 22B of the molding assembly 20. As will be appreciated, when the upper and lower halves 22A and 22B are closed, and the cavities 24A and 24B are aligned with each other, the resulting cavity 24 has a substantially spherical configuration. In a preferred embodiment, the golf ball precursor product 15 is a core 12 with a mantle layer 16. In an alternative embodiment, the golf ball precursor product 15 is only a core 12. Those skilled in the pertinent art will recognize that the golf ball precursor product may be other constructions without departing from the scope and spirit of the present invention. The interior surface wall 25 of the mold assembly 20 has an inverse aerodynamic pattern for forming an aerodynamic pattern in the cover of the golf ball. The inverse aerodynamic pattern is typically a plurality of raised regions on the interior surface wall 25.

As shown in FIGS. 2A and 2B, a plurality of protrusions 36 extend inward from the interior surface wall 25. The plurality of protrusions 36 hold the golf ball precursor product 15 in place within the cavity 24 during the cover formation process. The plurality of protrusions 36 are separated into at least two groups comprising a first plurality of protrusions located on a first side of the cavity 24 and a second plurality of protrusions located a second side of the cavity 24.

In FIG. 2A, an imaginary first mid-line separates a first side 505 from a second side 510. The first side 505 is a gate side and the first plurality of protrusions comprises protrusions 36a, 36b and 36f. The second side 510 is a vent side and the second plurality of protrusions comprises protrusions 36c, 36d and 36e. In this embodiment, at least one of the second plurality of protrusions 36c, 36d or 36e has a length that is greater than the length of each of the first plurality of protrusions 36a, 36b and 36f. More preferably, at least two or even all of the second plurality of protrusions 36c, 36d and 36e has a length that is greater than the length of each of the first plurality of protrusions 36a, 36b and 36f.

In FIG. 2B, an imaginary second mid-line separates a first side 520 from a second side 525. The first side 520 is a top side and the first plurality of protrusions comprises protrusions 36a, 36b and 36c. The second side 525 is a bottom side and the second plurality of protrusions comprises protrusions 36d, 36e and 36f. In this embodiment, at least one of the second plurality of protrusions 36d, 36e or 36f has a length that is greater than the length of each of the first plurality of protrusions 36a, 36b and 36c. More preferably, at least two or even all of the second plurality of protrusions 36d, 36e and 36f has a length that is greater than the length of each of the first plurality of protrusions 36a, 36b and 36c.

In a preferred embodiment, each of the first plurality of protrusions has a length that ranges from 0.005 inch to 0.050 inch, more preferably from 0.010 inch to 0.030 inch, and most preferably 0.024 inch or 0.021 inch. At least one of second plurality of protrusions has, and more preferably all of the second plurality of protrusions have, a length that is 0.0005 inch to 0.0050 inch greater than the length of each of the first plurality of protrusions, more preferably 0.0010 inch to 0.0030 inch greater and most preferably 0.002 inch greater. In a most preferred embodiment, each of the second plurality of protrusions has a length of 0.026 inch or 0.023 inch depending on the length of the first plurality of protrusions. One method of determining the necessary length of the second plurality of protrusions relative to the first plurality is to measure the concentricity of a cover formed using non-bias protrusions, wherein all of the protrusions have the same length.

As shown in FIG. 2, each upper and lower half 22A and 22B of the molding assembly 20 defines an adapter portion 26A and 26B to enable the molding assembly 20 to connect to other process equipment as mentioned above and leads to a material inlet channel 28A and 28B. As will be understood, upon closing the upper and lower halves 22A and 22B of the molding assembly 20, the separate halves of adapter portion 26A and 26B are aligned with each other and create a material flow inlet within the molding assembly 20. Each upper and lower half 22A and 22B of the assembly 20 further defines flow channels 28A and 28B, 30A and 30B and 32A and 32B which create a comprehensive flow channel within the molding assembly 20 when the upper and lower halves 22A and 22B are closed. Specifically, the material flow inlet channel portion 28A, 28B receives the constituent materials from the adapter portion 26A and 26B and directs those materials to a turbulence-promoting portion of the channel 30A, 30B which is configured to form at least one gate 34 in flow communication with the cavity 24. The upper and lower mold halves 22A and 22B include complimentary turbulence-promoting peanut after-mixer channel portions 30A and 30B, respectively. It will be appreciated that upon closing the upper and lower halves 22A and 22B of the molding assembly 20, the channel portion 30A and 30B defines a region of the flow channel that is generally nonlinear and includes a plurality of bends and at least one branching intersection generally referred to herein as an after-mixer gate. Each after-mixer channel portion 30A, 30B is designed to direct material flow along an angular or tortuous path. As will be described in more detail below, when material reaches a terminus of angular flow in one plane of the flow channel in one half, the material flows in a transverse manner to a corresponding after-mixer channel portion in the opposing half. Thus, when the constituent materials arrive at the after-mixer defined by the channel portion 30A and 30B, turbulent flow is promoted, forcing the materials to continue to mix within the molding assembly 20. This mixing within the molding assembly 20 provides for improved overall mixing of the constituent materials, thereby resulting in a more uniform and homogeneous composition for the cover 14.

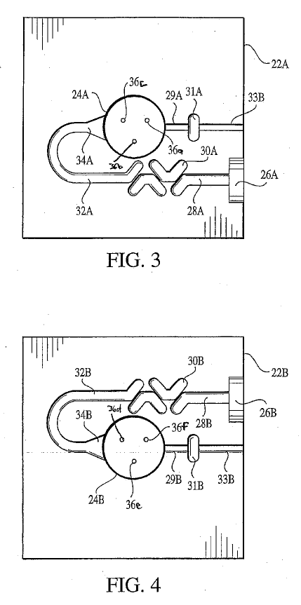

As shown in FIGS. 3 and 4, the material inlet channel 28A and 28B allows entry of the constituents which are subsequently directed through the mix-promoting channel portion 30A and 30B, which forms the after-mixer, then through the connecting channel portion 32A and 32B and to the fan gate portion 34A and 34B which leads into the cavity 24A and 24B. The final channel portion 34A and 34B may be defined in several forms extending to the cavity 24A and 24B, including corresponding or complimentary paths which may be closed (34A) or open (34B) and of straight, curved or angular (34A, 34B) shape.

The preferred dimensions, configuration, and orientation of the protrusions 36 are explained in greater detail herein. The protrusions 36 form the deep apertures 18 in the outer surface of a golf ball 10. Preferably, only three protrusions 36 or less may be necessary per mold half 22A and 22B. For some embodiments, it is preferred to utilize six protrusions 36 per mold half 22A and 22B. The use of fewer supporting structures reduces the cost of the tooling and reduces problems such as defacement and surface imperfections caused by retractable pins. The protrusions 36 are preferably provided at different locations in the molding assembly 20 and extend into different portions of the cavity 24 formed by the hemispherical cavities 24A, 24B. A vent 29 is preferably provided as either a cavity venting channel or an overflow channel or dump well as known in the art. As shown in FIG. 2, a dump well 31A, 31B is provided in the corresponding mold halves 22A and 22B. A dump well vent 33A, 33B provides communication between the dump well and mold exterior. A venting channel 29A, 29B is defined in the molds and provides communication between the central cavity 24A, 24B and the dump well. It will be appreciated that when the upper and lower halves 22A and 22B are closed, the respective portions of the channel align with one another to form the vent 29.

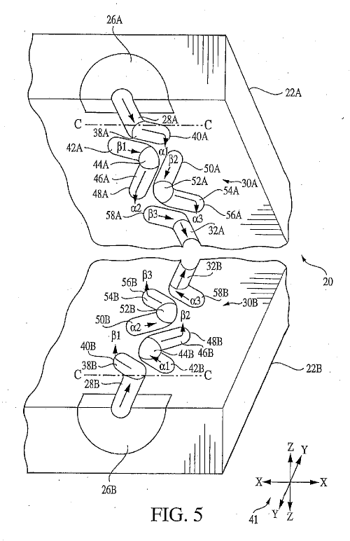

As shown in FIG. 5, the body halves 22A and 22B are shown in an open position, i.e., removed from one another, for purposes of illustration only. It will be appreciated that the material flow described below takes place when the halves 22A and 22B are closed. The adapter portion 26A, 26B leads to the inlet flow channel 28A, 28B which typically has a uniform circular cross section of 3608. The flowing material proceeds along the inlet channel 28A, 28B until it arrives in a location approximately at a plane designated by line C-C. At this region, the material is forced to split apart by a branching intersection 38A and 38B. Each half of the branching intersection 38A and 38B is divergent, extending in a direction generally opposing the other half. For example, portion 38A extends upward and 38B extends downward relative to the inlet channel 28A, 28B as shown. Each half of the branching intersection 38A and 38B, in the illustrated embodiment, is semicircular, or about 1808 in curvature. The separated material flows along each half of the branching intersection 38A and 38B until it reaches a respective wall, 40A and 40B.

At each first wall 40A and 40B, the material can no longer continue to flow within the plane of the closed mold, i.e., the halves 22A and 22B being aligned with one another. To aid the present description it will be understood that in closing the mold, the upper half 22A is oriented downward (referring to FIG. 5) so that it is generally parallel with the lower half 22B. The orientation of the halves 22A and 22B in such a closed configuration is referred to herein as lying in an x-y plane. As explained in greater detail herein, the configuration of the present invention after-mixer provides one or more flow regions that are transversely oriented to the x-y plane of the closed mold. Hence, these transverse regions are referred to as extending in a z direction.

Specifically, at the first wall 40A the material flows from a point 1 in one half 22A to a corresponding point 1 in the other half 22B. Point 1 in half 22B lies at the commencement of a first convergent portion 42B. Likewise, at the first wall 40B the material flows from a point 1 in one half 22B to a corresponding point 1 in the other half 22A. The point 1 in half 22A lies at the commencement of a first convergent portion 42A. The first convergent portion 42A and 42B brings the material to a first common area 44A and 44B. In the shown embodiment, each first convergent portion is parallel to each first diverging branching intersection to promote a smooth material transfer. For example, the portion 42A is parallel to the portion 38A, and the portion 42B is parallel to the portion 38B.

With continuing reference to FIG. 5, the flowing material arrives at the first common area 44A and 44B, which has a full circular, i.e., 360 degrees, cross section when the halves 22A and 22B are closed. Essentially, the previously separated material is rejoined in the first common area 44A and 44B. A second branching intersection 46A and 46B which is divergent then forces the material to split apart a second time and flow to each respective second wall 48A and 48B. As with the first wall 40A and 40B, the material, upon reaching the second wall 48A and 48B can no longer flow in an x-y plane and must instead move in a transverse z-direction. For example, at the wall 48A, the material flows from a point α2 in one half 22A to a corresponding point α2 in the other half 22B, which lies in a second convergent portion 50B. The material reaching the wall 48B flows from a point β2 in one half 22B to a corresponding point β2 in the other half 22A, which lies in a second convergent portion 50A.

In the shown embodiment, each second convergent portion 50A and 50B, is parallel to each second diverging branching intersection 46A and 46B. For example, the portion 50A is parallel to the portion 46A and the portion 50B is parallel to the portion 46B. The second convergent portion 50A and 50B forces the material into a second common area 52A and 52B to once again rejoin the separated material. As with the first common area 44A and 44B, the second common area 52A and 52B has a full circular cross section.

After the common area 52A and 52B, a third branching intersection 54A and 54B again diverges, separating the material and conveying it in different directions. Upon reaching each respective third wall, i.e., the wall 56A in the portion 54A and the wall 56B in the portion 54B, the material is forced to again flow in a transverse, z-direction from the planar x-y direction. From a point 3 at the third wall 56A in one half 22A, the material flows to a corresponding point 3 in the other half 22B, which lies in a third convergent portion 58B. Correspondingly, from a point 3 at third wall 56B in one half 22B, the material flows to a corresponding point 3 in the other half 22A, which is in a third convergent portion 58A.

The turbulence-promoting after-mixer structure 30A and 30B ends with a third convergent portion 58A and 58B returning the separated material to the connecting flow channel 32A and 32B. The connecting channel 32A and 32B is a common, uniform circular channel having a curvature of 360 degrees. Once the material enters the connecting channel portion 32A and 32B, typical straight or curved smooth linear flow recommences.

Separating and recombining materials repeatedly as they flow provides for increased mixing of constituent materials for introduction into the cavity 24. Through the incorporation of split channels and transverse flow, mixing is encouraged and controlled while the flow remains uniform, reducing back flow or hanging-up of material, thereby reducing the degradation often involved in non-linear flow. Particular note is made of the angles of divergence and convergence of the after-mixer portions 38A and 38B, 42A and 42B, 46A and 46B, 50A and 50B, 54A and 54B and 58A and 58B, as each extends at the angle of about 30 degrees to 60 degrees from the centerline of the linear inlet flow channel 28A, 28B. This range of angles allows for rapid separation and re-convergence while minimizing back flow. In addition, each divergent branching portion and converging portion 38A and 38B, 42A and 42B, 46A and 46B, 50A and 50B, 54A and 54B and 58A and 58B extends from the centerline of the linear inlet flow channel 28A, 28B for a distance of one to three times the diameter of the channel 28A, 28B before reaching its respective wall 40A and 40B, 48A and 48B and 56A and 56B. Further note is made of the common areas 44A and 44B and 52A and 52B. These areas are directly centered about a same linear centerline which extends from the inlet flow channel portion 28A, 28B to the commencement of the connecting flow channel portion 32A, 32B. As a result, the common areas 44A and 44B and 52A and 52B are aligned linearly with the channel portions 28A, 28B and 32A, 32B, providing for more consistent, uniform flow. While several divergent, convergent, and common portions are illustrated, it is anticipated that as few as one divergent and convergent portion or as many as ten to twenty divergent and convergent portions may be used, depending upon the application and materials involved.

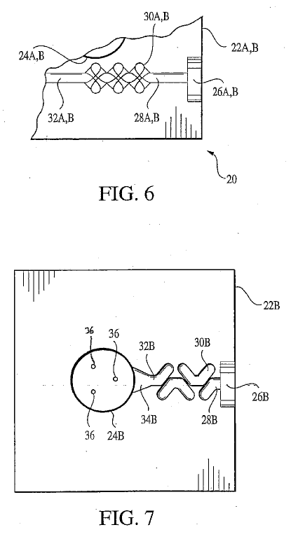

FIG. 6 depicts the turbulence-promoting after-mixer channels 30A, 30B from a side view when the molding assembly 20 is closed. As described above, upon closure, the upper half 22A and the lower half 22B meet, thereby creating the turbulence-promoting after-mixer along the region of the channel portions 30A and 30B. The resulting flow pathway causes the constituent materials flowing therethrough to deviate from a straight, generally linear path to a nonlinear turbulence-promoting path. The interaction and alignment of the divergent branching intersections 38A and 38B, 46A and 46B, 54A and 54B (referencing back to FIG. 5), the convergent portions 42A and 42B, 50A and 50B, 58A and 58B, and the common portions 44A and 44B, and 52A and 52B, also as described above, is shown in detail.

In a particularly preferred embodiment, the after-mixer includes a plurality of bends or arcuate portions that cause liquid flowing through the fan gate to not only be directed in the same plane in which the flow channel lies, but also in a second plane that is perpendicular to the first plane. It is most preferable to utilize an after-mixer with bends such that liquid flowing therethrough travels in a plane that is perpendicular to both the previously noted first and second planes. This configuration results in relatively thorough and efficient mixing due to the rapid and changing course of direction of liquid flowing therethrough.

The configuration of the mold channels may take various forms. One such variation is shown in FIG. 7. Reference is made to the lower mold half 22B for the purpose of illustration, and it is to be understood that the upper mold half 22A (not shown) comprises a complimentary configuration. The adapter portion 26B leads to the inlet flow channel 28B which leads to the turbulence-promoting channel portion 30B. However, instead of the adapter 26B and the channels 28B and 30B being spaced apart from the central cavity 24B, they are positioned approximately in line with the central cavity 24B, eliminating the need for the connecting channel portion 32B to be of a long, curved configuration to reach the fan gate portion 34B. Thus, the connecting channel 32B is a short, straight channel, promoting a material flow path which may be more desirable for some applications. The flow channels and the central cavity may be arranged according to other forms similar to those shown, which may occur to one skilled in the art, as equipment configurations and particular materials and applications dictate. FIG. 7 also illustrates one or more nonretractable protrusions 36 in the molding chamber.

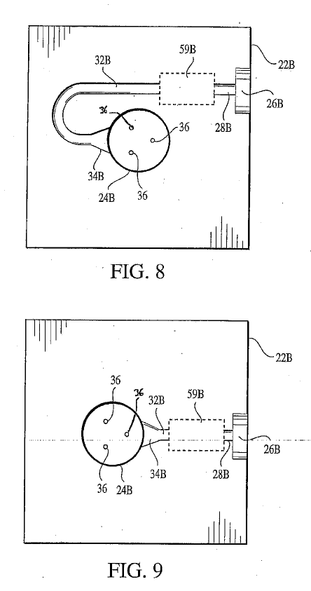

In the above-referenced figures, the channels 30A and 30B are depicted as each comprising a plurality of angled bends or turns. Turning now to FIG. 8, the channels are not limited to the angled bend-type fan gate configuration and include any turbulence-promoting design located in a region 59B between the adapter portion 26B and the cavity 24B. Again, reference is made to the lower mold half 22B for the purpose of illustration, and it is to be understood that the upper mold half 22A (not shown) is complimentary to the lower mold half 22B. The channels in the turbulence-promoting region 59A (not shown) and 59B could be formed to provide one or more arcuate regions such that upon closure of the upper and lower mold halves 22A and 22B, the flow gate has, for example, a spiral or helix configuration. Regardless of the specific configuration of the channels in the turbulence promoting portion 59A and 59B, the shape of the resulting flow gate insures that the materials flow through the turbulence-promoting region and thoroughly mix with each other, thereby reducing typical straight laminar flow and minimizing any settling in a low-flow area where degradation of flow may occur. Preferably, the shape and configuration of the flow channel is such that the velocity of the materials flowing therethrough is generally constant at different locations along the channel.

As shown in FIG. 9, the turbulence-promoting region 59A (not shown) and 59B may be placed in various locations in the upper and lower mold halves 22A (not shown) and 22B. As mentioned above, the turbulence-promoting region 59B and the other flow channel portions 28B, 32B, and 34B may be arranged so as to create an approximately straight layout between the adapter portion 26B and the central cavity 24B.

Gases, including air and moisture, are often present in a RIM process and create undesirable voids in the molded cover 14. Venting of cavity 24 reduces voids by removing these gases. Through the use of venting, a cover 14 is provided that is significantly more free from voids or other imperfections than a cover produced by a non-vented RIM process.

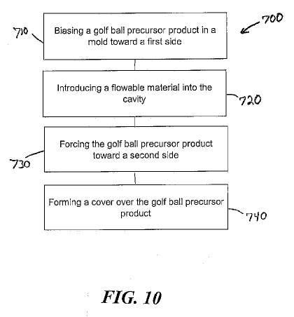

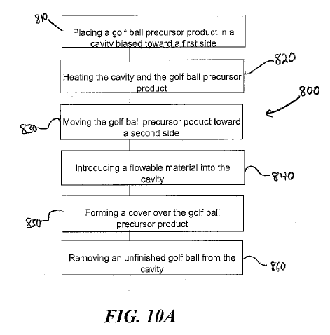

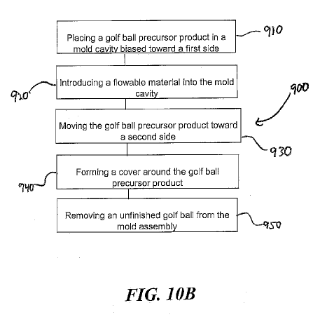

A preferred method 700 of forming a golf ball in accordance with the present invention is illustrated in FIG. 10. At block 710, a golf ball precursor product 15 is biased within a cavity 24 of a mold assembly 20 toward a first side of an interior surface wall 25. The golf ball precursor product 15 is preferably biased using protrusions 36 extending from a second side that have a greater length than protrusions 36 extending from the first side. At block 720, a flowable material is introduced into the cavity 24. At block 730, the golf ball precursor product 15 is forced toward the second side. At block 740, a cover 14 is formed over the golf ball precursor product 15.

Another method 800 is shown in the flow chart of FIG. 10A. At block 810, a golf ball precursor product 15 is biased within a cavity 24 of a mold assembly 20 toward a first side of an interior surface wall 25. The golf ball precursor product 15 is preferably biased using protrusions 36 extending from a second side that have a greater length than protrusions 36 extending from the first side. At block 820 the cavity 24 and the golf ball precursor product 15 are heated, which results in a softening of a material composition of the golf ball precursor product 15. At block 830, the golf ball precursor product 15 moves toward a second side due to the softening of the material composition and gravity. At block 840, a flowable material is introduced into the cavity 24. At block 850, a cover 14 is formed over the golf ball precursor product 15. At block 860, an unfinished golf ball having a cover 14 formed over a golf ball precursor product 15 is removed from the cavity 20.

Another method 900 is shown in the flow chart of FIG. 10B. At block 910, a golf ball precursor product 15 is biased within a cavity 24 of a mold assembly 20 toward a first side of an interior surface wall 25. The golf ball precursor product 15 is preferably biased using protrusions 36 extending from a second side that have a greater length than protrusions 36 extending from the first side. At block 920, a flowable material is introduced into the cavity 24. At block 930, the golf ball precursor product 15 moves toward the second side due to the force of the flowable material in the cavity 24. At block 940, a cover 14 is formed over the golf ball precursor product 15. At block 950, an unfinished golf ball having a cover 14 formed over a golf ball precursor product 15 is removed from the cavity 20.

A golf ball manufactured according the preferred method described herein exhibits unique characteristics. Preferably the cover 14 has, on average, greater concentricity than prior art golf balls. In a preferred embodiment, the cover 14 has a concentricity within 0.003 inch, which means the difference in the minimum thickness of the cover 14 and the maximum thickness of the cover 14 is within 0.003 inch when measured at similarly designed points on the cover 14. For example, for a golf ball with a dimpled aerodynamic pattern, the minimum thickness and the maximum thickness are measured at lands areas of the cover 14 as opposed to measuring a land area for the maximum thickness and a bottom of a dimple for the minimum thickness.

Some of the unique characteristics exhibited by a golf ball according to the present invention include a thinner cover without the accompanying disadvantages otherwise associated with relatively thin covers such as weakened regions at which inconsistent compositional differences exist. A traditional golf ball cover typically has a total thickness in the range of about 0.060 inch to 0.080 inch. A golf ball of the present invention may utilize a cover having a thickness of from about 0.002 inch to about 0.100 inch, more preferably from about 0.005 inch to about 0.050 inch, more preferably from about 0.010 inch to about 0.025 inch, and most preferably about 0.021 inch or about 0.018 inch.

Because of the reduced pressure involved in reaction injection molding as compared to traditional injection molding, an outer cover or any other layer of the present invention golf ball is more dependably concentric and uniform with the core of the ball, thereby improving ball performance. That is, a more uniform and reproducible geometry is attainable by employing the present invention.

A preferred temperature range for the method of the invention is from about 50° F. to about 250° F. and preferably from about 120° F. to about 180° F. Preferred pressures for practicing the invention range from 50 psi to 1000 psi. The method of the present invention results in molded covers in a demold time of 10 minutes or less.

In reaction injection molding (“RIM”), highly reactive liquids are injected into a closed mold, mixed usually by impingement and/or mechanical mixing and secondarily mixed in an in-line device such as a peanut mixer, where they polymerize primarily in the mold to form a coherent, one-piece molded article. The RIM processes usually involve a rapid reaction between one or more reactive components such as polyether- or polyester-polyol, polyamine, or other material with an active hydrogen, and one or more isocyanate-containing constituents, often in the presence of a catalyst. The constituents are stored in separate tanks prior to molding and may be first mixed in a mix head upstream of a mold and then injected into the mold. The liquid streams are metered in the desired weight to weight ratio and fed into an impingement mix head, with mixing occurring under high pressure, e.g., 1500 to 3000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane polymers. Polyureas, epoxies, and various unsaturated polyesters also can be molded by RIM.

The reaction mixture viscosity is preferably sufficiently low to ensure that the empty space in the mold is completely filled. The reactant materials preferably are preheated to about 80° F. to about 200° F. and preferably to 100° F. to about 180° F. before mixing. In most cases it is necessary to preheat the mold to, e.g., from about 80° F. to about 200° F., to provide for proper injection viscosity. A more thorough discussion of the RIM process is set forth in U.S. Pat. No. 6,855,073 for a Golf ball Which Includes Fast-Chemical-Reaction-Produced Component And Method Of Making The Same, which is hereby incorporated by reference in its entirety.

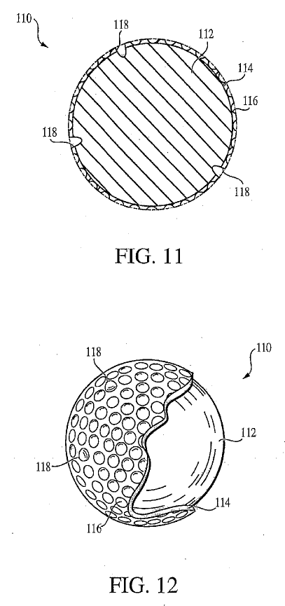

As shown in FIGS. 11 and 12, a two-piece golf ball having a cover comprising a RIM polyurethane is shown. The golf ball 110 includes a polybutadiene core 112 and a polyurethane cover 114 formed by RIM. The golf ball 110 defines a plurality of dimples 116 along its outer surface. Preferably, the ball 110 also defines one or more deep apertures 118 as described in greater detail herein.

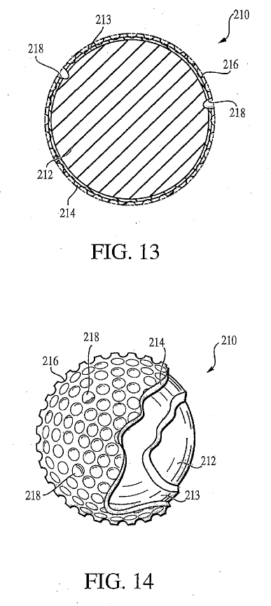

As shown in FIGS. 13 and 14, a multi-layer golf ball 210 is shown with a solid core 212, a mantle layer 213, and a cover layer 214. Non-limiting examples of multi-layer golf balls have a mantle layer 213 with a thickness of 0.01 inch to 0.20 inch, or thinner, and a Shore D hardness of 20 to 80. The golf ball 210 defines a plurality of dimples 216 along its outer surface. Preferably, the ball 210 also defines one or more deep apertures 218 as described in greater detail herein.

Referring again to FIGS. 11 and 12, those figures illustrate a preferred embodiment golf ball 110 produced in accordance with the present invention. One or more of the deep apertures 120, and preferably two or more of the apertures 120, and more preferably three or more of the apertures per hemisphere, extend into the core 112 disposed underneath the cover layer 114.

The preferred embodiment golf ball 210 shown in FIGS. 13 and 14 comprises a core 212 having an inner cover layer 213 disposed thereon and an outer cover layer 214 formed about the inner cover layer 213. The cover layers 213 and 214 define a plurality of apertures 218 along the outer surface of the outer cover layer 160. One or more of the apertures, and preferably two or more of the apertures, and more preferably three or more of the apertures per hemisphere, extend entirely through the outer cover layer 214 and at least partially into or to the inner cover layer 213.

The deep apertures can be circular, non-circular, a combination of circular and non-circular, or any other shape desired. They may be of the same or differing shape, such as a circular larger dimple having an oval smaller dimple within the circular dimple, or an oval larger dimple having a circular or other shape within the larger dimple. The apertures do not have to be symmetrical.

Providing deep apertures formed in multiple layers allows the depth to be spread over two or more layers. FIG. 13 illustrates deep aperture 220 formed in both the inner cover layer and the outer cover layer. The inner portion of the aperture 220 is formed in the inner cover layer 213, and the outer portion of the aperture 220 is formed in the outer cover layer 214. For a two-piece ball, apertures may be formed in the core and the single cover layer in the same way as previously described. Additionally, apertures may be formed in more than two cover and/or core layers if desired.

As illustrated in Table One and Table Two, golf balls formed in a non-biased protrusion method (all of the protrusions have the same length) were compared to biased golf balls formed according to the present invention in which the three vent side protrusions each had a greater length than each of the three gate side protrusions. Both the non-biased golf balls and biased golf balls were formed in a polyurethane reaction injection molding process such as disclosed in U.S. Pat. No. 6,855,077.

For Table One, twenty-four non-biased golf balls were formed and measured and twenty-four biased golf balls were formed and measured. The cover thickness was measured at eight points (two top points, two bottom points, two gate side points and two vent side points) on each golf ball. The minimum thickness for each golf ball was used to calculate the cover thickness average minimum (based on 24 measurements). The maximum thickness for each golf ball was used to calculate the cover thickness average maximum (based on 24 measurements). The centering data max-min average is the cover thickness average maximum minus the cover thickness average minimum. As shown in Table One, the biased golf balls of the present invention were much more concentric than the non-biased golf balls.

As shown in Table Two, the launch properties of the non-biased golf balls were compared to launch properties of the biased golf balls. Three types of launch conditions were measured for each of the golf balls: amateur, professional and USGA. The amateur conditions were at a launch velocity of 169 feet per second (“ft/sec”), the professional conditions were at a launch velocity of 237 ft/sec, and the USGA conditions were at a launch velocity of 257 ft/sec. As shown in Table Two, the biased golf balls had better total distance (carry+roll) than the non-biased golf balls.

TABLE ONE

| | Cover Thickness | Cover Thickness | |
|---|---|---|---|
| | Average | Average | Centering Data |
| Golf Ball | Minimum | Maximum | Max-min Average |
| Non-biased | 0.0197 inch | 0.0246 inch | 0.0049 inch |
| Biased | 0.0200 inch | 0.0238 inch | 0.0028 inch |

TABLE TWO

| | Amateur | Professional | USGA |
|---|---|---|---|
| Golf Ball | Total Yards | Total Yards | Total Yards |
| Non-biased | 231.4 | 283.2 | 308.8 |
| Biased | 232.0 | 284.0 | 309.6 |

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

What is claimed is:

1. A method for forming a golf ball, the method comprising:
placing a golf ball precursor product within a cavity of a mold, an interior surface wall of the mold defining the cavity, the interior surface wall of the mold having a first side and a second side, the golf ball precursor product positioned on a first plurality of protrusions extending from the first side and a second plurality of protrusions extending from the second side, at least one protrusion of the second plurality of protrusions having a length as measured from the interior surface wall inward toward the cavity that is greater than the length of each of the first plurality of protrusions;
introducing a flowable material into the cavity;
moving the golf ball precursor product toward the second side of the interior surface of the mold from a force; and
forming a cover from the flowable material over the golf ball precursor product, the cover having a plurality of deep apertures formed by each of the first plurality of protrusions and the second plurality of protrusions.

2. The method according to claim 1 wherein the first side is a gate side and the second side is a vent side and the moving of the golf ball precursor product from the first side to the second side is from the force of the flowable material introduced into the cavity.

3. The method according to claim 1 wherein the first side is a top side and the second side is a bottom side and the moving of the golf ball precursor product from the first side to the second side is from a force of gravity.

4. The method according to claim 3 further comprising softening a material of the golf ball precursor product prior to moving the golf ball precursor product.

5. The method according to claim 1 wherein the golf ball precursor product is selected from the group consisting of a core, a core and a mantle layer, and a dual core and a mantle layer.

6. The method according to claim 1 wherein the flowable material is a reacting mixture comprising an isocyanate component and a polyol component.

7. The method according to claim 1 wherein the cover comprises a polyurethane material having a thickness ranging from 0.010 inch to 0.050 inch.

8. The method according to claim 1 wherein each of the first plurality of protrusions has a length ranging from 0.005 inch to 0.050 inch.

9. The method according to claim 1 wherein the flowable material is introduced into the cavity at a force ranging from 50 psi to 1000 psi.

10. The method according to claim 1 wherein the at least one protrusion of the second plurality of protrusions has a length that is from 0.0005 inch to 0.005 inch greater than the length of each of the first plurality of protrusions.

11. The method according to claim 1 wherein the interior surface wall has an inverse aerodynamic pattern surface which forms an aerodynamic pattern in the cover of the golf ball, the aerodynamic pattern selected from the group consisting of a tubular lattice pattern and a dimple pattern.

12. The method according to claim 1 wherein the first plurality of protrusions consists of three protrusions each having a length ranging from 0.005 inch to 0.050 inch, the second plurality of protrusions consists of three protrusions each having a length that is from 0.0005 inch to 0.005 inch greater than the length of each of the first plurality of protrusions.

13. The method according to claim 1 wherein the first plurality of protrusions consists of three protrusions each having a length of 0.024 inch, and the second plurality of protrusions consists of three protrusions each having a length of 0.026 inch.

14. The method according to claim 1 wherein the first plurality of protrusions consists of three protrusions each having a length of 0.021 inch, and the second plurality of protrusions consists of three protrusions each having a length of 0.023 inch.

15. A method for forming a golf ball, the method comprising:
biasing a golf ball precursor product toward a first side of an interior surface wall which defines a cavity of a reaction injection mold;
introducing a flowable material into the cavity, the flowable material consisting of a reacting mixture of a isocyanate component and a polyol component, the flowable material introduced into the cavity at a force ranging from 50 psi to 1000 psi;
forcing the golf ball precursor product toward a second side of the interior surface wall; and
forming a reaction injection molded polyurethane cover over the golf ball precursor product, the reaction injection molded polyurethane cover having a thickness ranging from 0.010 inch to 0.050 inch and a concentricity within 0.003 inch.

16. The method according to claim 15 wherein the first side is a gate side and the second side is a vent side and the forcing of the golf ball precursor product from the first side to the second side is from the force of the flowable material introduced into the cavity.

17. The method according to claim 15 wherein the first side is a top side and the second side is a bottom side and the forcing of the golf ball precursor product from the first side to the second side is from a force of gravity.

18. The method according to claim 17 further comprising softening a material of the golf ball precursor product prior to forcing the golf ball precursor product.

19. The method according to claim 15 wherein the golf ball precursor product is selected from the group consisting of a core, a core and a mantle layer, and a dual core and a mantle layer.

20. An apparatus for forming a golf ball, the apparatus comprising:
an interior surface wall defining a cavity, the interior surface wall having a first side and a second side, the interior surface wall having an inverse aerodynamic pattern surface;
a first plurality of protrusions extending from the first side of the interior surface wall, each of the first plurality of protrusions having a first length;
a second plurality of protrusions extending from the second side of the interior surface wall, at least one protrusion of the second plurality of protrusions having a second length which is greater than the first length;
a flow channel for introducing a flowable material into the cavity through a gate in the interior surface wall; and
an exit channel for receiving excess flowable material from the cavity through a vent located in the interior surface wall.

21. The apparatus according to claim 20 wherein the at least one protrusion of the second plurality of protrusions has a length that is from 0.0005 inch to 0.005 inch greater than the length of each of the first plurality of protrusions.

22. The method according to claim 20 wherein the interior surface wall has an inverse aerodynamic pattern surface which forms an aerodynamic pattern in the cover of the golf ball, the aerodynamic pattern selected from the group consisting of a tubular lattice pattern and a dimple pattern.

23. The method according to claim 20 wherein the first plurality of protrusions consists of three protrusions each having a length ranging from 0.005 inch to 0.050 inch, the second plurality of protrusions consists of three protrusions each having a length that is from 0.0005 inch to 0.005 inch greater than the length of each of the first plurality of protrusions.

24. The method according to claim 20 wherein the first plurality of protrusions consists of three protrusions each having a length of 0.024 inch, and the second plurality of protrusions consists of three protrusions each having a length of 0.026 inch.

25. The method according to claim 20 wherein the first plurality of protrusions consists of three protrusions each having a length of 0.021 inch, and the second plurality of protrusions consists of three protrusions each having a length of 0.023 inch.

26. A golf ball comprising:
a golf ball precursor product having a diameter ranging from 1.54 inches to 1.70 inches; and
a cover disposed over the golf ball precursor product, the cover formed from a reaction injection molded polyurethane, the cover having a thickness ranging from 0.010 inch to 0.050 inch, a surface of the cover having an aerodynamic pattern, the cover having a first plurality of deep apertures on a first hemisphere of the golf ball and a second plurality of deep apertures on a second hemisphere of the golf ball, the first plurality of deep apertures having a first depth and the second plurality of deep apertures having a second depth, wherein the second depth is greater than the first depth, each of the first plurality of deep apertures and the second plurality of deep apertures extending through the cover.

27. The golf ball according to claim 26 wherein the second depth is from 0.0005 inch to 0.005 inch greater than the first depth.

28. The golf ball according to claim 26 wherein the golf ball precursor product is selected from the group consisting of a core, a core and a mantle layer, and a dual core and a mantle layer.

29. The golf ball according to claim 26 wherein the cover has a maximum thickness of 0.021 inch, the first depth is 0.024 inch and the second depth is 0.026 inch.

30. The golf ball according to claim 26 wherein the cover has a maximum thickness of 0.018 inch, the first depth is 0.021 inch and the second depth is 0.023 inch.
